(19) United States
(12) Patent Application Publication
(10) Pub. No.: US 2023/0106134 A1
(43) Pub. Date: Apr. 6, 2023

(54) WAREHOUSE ROBOT CONTROL METHOD AND APPARATUS, DEVICE, AND READABLE STORAGE MEDIUM

(71) Applicant: HAI ROBOTICS CO., LTD., Shenzhen (CN)

(72) Inventors: Huixiang LI, Shenzhen (CN); Jui-chun CHENG, Shenzhen (CN); Yuqi CHEN, Shenzhen (CN)

(21) Appl. No.: 18/064,609

(22) Filed: Dec. 12, 2022

Related U.S. Application Data
(63) Continuation of application No. PCT/CN2021/102865, filed on Jun. 28, 2021.

(30) Foreign Application Priority Data
Jun. 12, 2020 (CN) 202010537646.9

(51) Int. Cl. B65G 1/137; G06T 7/70; G06T 7/00

(52) U.S. Cl. CPC B65G 1/1373; G06T 7/70; G06T 7/0004; B65G 2203/0233; B65G 2203/041; G06T 2207/10028

(57) ABSTRACT

The present disclosure provides a warehouse robot control method and apparatus, a device and a readable storage medium. According to the method of the present disclosure, before a carrying task is executed, image data of a target storage location is acquired through an image acquisition apparatus, whether an execution condition of a carrying task is satisfied is determined according to the image data of the target storage location, and in a case that the execution condition of the carrying task is satisfied, that is, no danger may happen during execution of the carrying task by a carrying apparatus, the carrying apparatus is controlled to execute the carrying task. The occurrence of danger is avoided and the safety of warehouse robots is improved.

### CROSS-REFERENCE TO RELATED APPLICATIONS

This application is a continuation of International Patent Application No. PCT/CN2021/102865 filed on Jun. 28, 2021, which claims priority to Chinese Patent Application No. 202010537646.9, filed on Jun. 12, 2020, which is incorporated herein by reference in its entirety.

### TECHNICAL FIELD

The present disclosure relates to the field of intelligent warehousing, and to a warehouse robot control method and apparatus, a device and a readable storage medium.

### BACKGROUND

Along with networking and intelligentizing of intelligent manufacture and the field of warehousing and logistics, warehousing and logistics play a significant role in production and management processes of enterprises. In the field of intelligent warehousing, it becomes more and more common for warehouse robots to replace workers in carrying goods.

In existing intelligent warehousing systems, because vibration of a rack or a manual operation error, etc. may cause a material box to shift within a storage location or fall off from the rack. In a case that a warehouse robot picks up a material box or passes by the material box, the warehouse robot may collide with the material box. Therefore, there is a safety hazard during pickup and storage of a material box by a warehouse robot.

### SUMMARY

The present provides a warehouse robot control method and apparatus, a device and a readable storage medium, for solving the problem of low safety of warehouse robots.

One aspect of the present disclosure provides a warehouse robot control method. The warehouse robot has a carrying apparatus and an image acquisition apparatus. The method includes:

acquiring image data of a target storage location corresponding to a carrying task through the image acquisition apparatus; and controlling, according to the image data of the target storage location, the carrying apparatus to execute the carrying task in response to determining that an execution condition of the carrying task is satisfied.

In a possible implementation, the acquiring image data of a target storage location corresponding to a carrying task through the image acquisition apparatus includes:

controlling, in a case that the warehouse robot moves to a target location corresponding to the target storage location, the image acquisition apparatus to start and acquire the image data of the target storage location; or controlling, in a case that the warehouse robot moves within a preset range around the target storage location, the image acquisition apparatus to start and acquire the image data of the target storage location.

In a possible implementation, the image acquisition apparatus is disposed on the carrying apparatus, and before the controlling the image acquisition apparatus to start and acquire the image data of the target storage location, the method further includes:

controlling the carrying apparatus to be aligned with the target storage location.

In a possible implementation, the controlling, according to the image data of the target storage location, the carrying apparatus to execute the carrying task in response to determining that an execution condition of the carrying task is satisfied includes:

performing detection processing on the image data of the target storage location, and determining state information of the target storage location and/or state information of a target object; and controlling, according to the state information of the target storage location and/or the state information of the target object, the carrying apparatus to execute the carrying task in response to determining that the execution condition of the carrying task is satisfied.

In a possible implementation, the state information of the target storage location includes at least one of the following:

obstacle information on a carrying path of the target storage location; size information of the target storage location; and whether the target storage location is idle.

In a possible implementation, the state information of the target object includes at least one of the following:

identity information of the target object; pose information of the target object; size information of the target object; damage degree information of the target object; and deformation degree information of the target object.

In a possible implementation, the carrying task is a pickup task, and the execution condition of the carrying task includes at least one of the following:

no obstacle is present on a pickup path of the target storage location; the identity information, the pose information and the size information of the target object satisfy pickup conditions; a damage degree of the target object falls within a first preset safety threshold range; and a deformation degree of the target object falls within a second preset safety threshold range.

In a possible implementation, the carrying task is a storage task, and the execution condition of the carrying task includes at least one of the following:

the target storage location is idle; the size of the target storage location satisfies a storage condition; and no obstacle is present on a storage path of the target storage location.

In a possible implementation, the method further includes:

sending error information to a server according to the image data of the target storage location in response to determining that the execution condition of the carrying task is not satisfied, where the error information includes at least one of the following: the state information of target storage location, the state information of the target object, and an execution condition item which is not satisfied.

In a possible implementation, after the sending the error information to the server, the method further includes:

controlling, according to a scheduling instruction of the server, the warehouse robot to execute a corresponding error handling behavior.

In a possible implementation, the error handling behavior is any one of the following:

stopping at a current location and waiting for an instruction; moving to a target point; and skipping the current carrying task and executing a next carrying task.

In a possible implementation, the acquiring image data of a target storage location through the image acquisition apparatus includes at least one of the following:

acquiring, by a first camera apparatus, two-dimensional image data of the target storage location; acquiring, by a second camera apparatus, three-dimensional point cloud data of the target storage location; and acquiring, by a laser radar apparatus, two-dimensional point cloud data of the target storage location.

In a possible implementation, before the acquiring image data of a target storage location corresponding to a carrying task through the image acquisition apparatus, the method further includes:

controlling the warehouse robot to move to the target storage location in response to an execution instruction of the carrying task.

Another aspect of the present disclosure provides a warehouse robot control apparatus, applied to a warehouse robot having a carrying apparatus and an image acquisition apparatus. The warehouse robot control apparatus includes:

a data acquisition module, configured to acquire image data of a target storage location corresponding to a carrying task through the image acquisition apparatus; and

a control module, configured to control, according to the image data of the target storage location, the carrying apparatus to execute the carrying task in response to determining that an execution condition of the carrying task is satisfied.

In a possible implementation, the data acquisition module is further configured to:

control, in a case that the warehouse robot moves to a target location corresponding to the target storage location, the image acquisition apparatus to start and acquire the image data of the target storage location; or control, in a case that the warehouse robot moves within a preset range around the target storage location, the image acquisition apparatus to start and acquire the image data of the target storage location.

In a possible implementation, the image acquisition apparatus is disposed on the carrying apparatus, and the control modules is further configured to:

control the carrying apparatus to be aligned with the target storage location.

In a possible implementation, the control module is further configured to:

perform detection processing on the image data of the target storage location, and determine state information of the target storage location and/or state information of a target object; and control, according to the state information of the target storage location and/or the state information of the target object, the carrying apparatus to execute the carrying task in response to determining that the execution condition of the carrying task is satisfied.

In a possible implementation, the state information of the target storage location includes at least one of the following:

obstacle information on a carrying path of the target storage location; size information of the target storage location; and whether the target storage location is idle.

In a possible implementation, the state information of the target object includes at least one of the following:

identity information of the target object; pose information of the target object; size information of the target object; damage degree information of the target object; and deformation degree information of the target object.

In a possible implementation, the carrying task is a pickup task, and the execution condition of the carrying task includes at least one of the following:

no obstacle is present on a pickup path of the target storage location; the identity information, pose information and size information of the target object satisfy pickup conditions; a damage degree of the target object falls within a first preset safety threshold range; and a deformation degree of the target object falls within a second preset safety threshold range.

In a possible implementation, the carrying task is a storage task, and the execution condition of the carrying task includes at least one of the following:

the target storage location is idle; the size of the target storage location satisfies a storage condition; and no obstacle is present on a storage path of the target storage location.

In a possible implementation, the control module is further configured to:

send error information to a server according to the image data of the target storage location in response to determining that the execution condition of the carrying task is not satisfied, where the error information includes at least one of the following: the state information of target storage location, the state information of the target object, and an execution condition item which is not satisfied.

In a possible implementation, the control module is further configured to:

controlling, according to a scheduling instruction of the server, the warehouse robot to execute a corresponding error handling behavior.

In a possible implementation, the error handling behavior is any one of the following:

stopping at a current location and waiting for an instruction; moving to a target point; and skipping the current carrying task and executing a next carrying task.

In a possible implementation, the data acquisition module is further configured to execute one of the following:

acquiring, by a first camera apparatus, two-dimensional image data of the target storage location; acquiring, by a second camera apparatus, three-dimensional point cloud data of the target storage location; and acquiring, by a laser radar apparatus, two-dimensional point cloud data of the target storage location.

In a possible implementation, the control module is further configured to control the warehouse robot to move to the target storage location in response to an execution instruction of the carrying task.

Another aspect of the present disclosure provides a warehouse robot, including:

a carrying apparatus, an image acquisition apparatus, a processor, a memory, and a computer program stored on the memory and capable of running on the processor.

During the execution of the computer program, the processor implements the warehouse robot control method.

Another embodiment of the present disclosure provided a computer readable storage medium, having a computer program stored therein, and the computer program, when executed by a processor, implements the warehouse robot control method.

According to the warehouse robot control method and apparatus, the device and the readable storage medium provided by the present disclosure, before a carrying task is executed, image data of a target storage location corresponding to a carrying task is acquired through an image acquisition apparatus, whether an execution condition of a carrying task is satisfied is determined according to the image data of the target storage location, and in a case that the execution condition of the carrying task is satisfied, that is, no danger may happen during execution of the carrying task by a carrying apparatus, the carrying apparatus is controlled to execute the carrying task. The occurrence of danger is avoided, the safety of goods pickup and storage is improved, and possibilities of goods damage and rack toppling are reduced.

### BRIEF DESCRIPTION OF THE DRAWINGS

FIG. 1 is a flowchart of a warehouse robot control method provided in embodiment I of the present disclosure.

FIG. 2 is a flowchart of a warehouse robot control method provided in embodiment II of the present disclosure.

FIG. 3 is a schematic structural diagram of a warehouse robot control apparatus provided in embodiment III of the present disclosure.

FIG. 4 is a schematic structural diagram of a warehouse robot provided in embodiment V of the present disclosure.

The accompanying drawings illustrate explicit embodiments of the present disclosure, which will be described in detail in the following. These accompanying drawings and literal descriptions are not intended to limit the scope of the concept of the present disclosure by any means, but to explain the concept of the present disclosure to a person skilled in the art with reference to the specific embodiments.

### DETAILED DESCRIPTION

Exemplary embodiments will be described here in detail, and examples thereof are represented in the accompanying drawings. The following description refers to the accompanying drawings in which the same numbers in different drawings represent the same or similar elements unless otherwise indicated. The implementations described in the following exemplary embodiments do not represent all implementations consistent with the present disclosure. On the contrary, they are merely examples of apparatuses and methods consistent with some aspects of the present disclosure as detailed in the appended claims.

In addition, terms “first” and “second” are used merely for the purpose of description, and shall not be construed as indicating or implying relative importance or implying a quantity of indicated technical features. In the descriptions of the following embodiments, unless explicitly specified, “multiple” means two or more.

The present disclosure is specifically applied to an intelligent warehousing system. The intelligent warehousing system includes a warehouse robot, a scheduling system, and a warehouse, etc. The warehouse includes a plurality of storage locations for placing objects such as material boxes and goods. The warehouse robot replaces workers in carrying goods. The scheduling system communicates with the warehouse robot. For example, the scheduling system issues a carrying task to the warehouse robot, and the warehouse robot sends state information of task execution, etc. to the scheduling system.

In existing intelligent warehousing systems, because vibration of a rack or a manual operation error, etc. may cause a material box to shift within a storage location or fall off from the rack. In a case that a warehouse robot picks up a material box or passes by the material box, the warehouse robot may collide with the material box. Therefore, there is a safety hazard during pickup and storage of a material box by a warehouse robot.

A warehouse robot control method provided by the present disclosure is intended to solve the technical problems above.

The technical solutions of the present disclosure and how the technical solutions solve the aforementioned technical problems are described in detail in the specific embodiments hereinafter. The following specific embodiments can be combined with each other, and the same or similar concepts or processes may not be repeated in some embodiments. Embodiments of the present disclosure are described below with reference to the accompanying drawings.

### Embodiment I

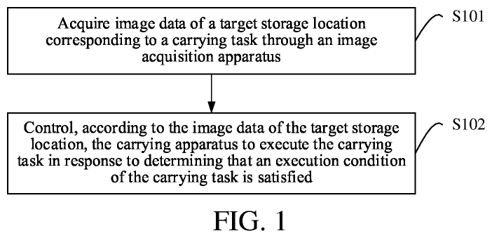

FIG. 1 is a flowchart of a warehouse robot control method provided in embodiment I of the present disclosure. The method in this embodiment is applied to a warehouse robot. In other embodiments, the method may also be applied to other devices. This embodiment takes a warehouse robot as an example for schematic description. The execution subject of the method in this embodiment may be a processor configured to control a warehouse robot to execute a carrying task, for example, a processor of a terminal device loaded on a warehouse robot. As shown in FIG. 1, the method includes the following specific steps:

Step S101. Acquire image data of a target storage location corresponding to a carrying task through an image acquisition apparatus.

The carrying task includes information of the corresponding target storage location, a task type, and other information required for executing a current task. Types of the carrying task includes a pickup task and a storage task.

The warehouse robot is provided with a carrying apparatus for pickup and/or storage. The carrying apparatus refers to an apparatus for picking up goods from a storage location or storing goods into a storage location, for example, a fork.

The image acquisition apparatus is an apparatus disposed on the warehouse robot and configured to acquire the image data of the storage location. For example, the image acquisition apparatus may be a 2D camera, a 3D camera, and a laser radar. In the present disclosure, the 2D camera is a camera data captured by which is plane data. A 2D camera is a common ordinary color camera or a black and white camera. The 3D camera is a camera data captured by which is stereo data, and the principles thereof are reflecting of structured light by an object and a visual difference of a binocular camera, etc. Common 3D cameras include Kinect, RealSense, etc.

Optionally, the image acquisition apparatus is disposed on the carrying apparatus of the warehouse robot. In a process that the warehouse robot moves to the target storage location, or in a case that the warehouse robot moves to the vicinity of the target storage location, the image acquisition apparatus mounted on the carrying apparatus acquires the image data of the target storage location.

Before executing the carrying task, the processor acquires the image data of the target storage location, to determine, according to the image data of the target storage location, whether an execution condition of the carrying task is satisfied currently.

Specifically, the processor controls the image acquisition apparatus to acquire the image data of the target storage location and send the image data of the target storage location to the processor. The processor receives the image data of the target storage location sent by the image acquisition apparatus, so as to acquire the image data of the target storage location in real time.

Step S102. Control, according to the image data of the target storage location, the carrying apparatus to execute the carrying task in response to determining that an execution condition of the carrying task is satisfied.

After the image data of the target storage location is acquired, the processor performs detection processing on the image data of the target storage location to detect state information of the target storage location and/or state information of an object in the target storage location, and determines, according to the state information of the target storage location and/or the state information of the object in the target storage location, whether the execution condition of the carrying task is satisfied currently.

Exemplarily, the state information of the target storage location includes whether the target storage location is idle, a size, whether an obstacle is present on a path on which the carrying apparatus picks up goods from the target storage location or stores goods into the target storage location, etc. The state information of the object in the target storage location includes identity, size, pose, damage degree, deformation degree, etc.

In addition, information detected according to the image data of the target storage location may change according to actual application scenes, and this is not limited in this embodiment.

In a case that it is determined that the execution condition of the carrying task is satisfied, under a current condition, no danger may happen to the carrying apparatus executing the carrying task, and the carrying apparatus is controlled to execute the carrying task.

In a case that it is determined that the execution condition of the carrying task is not satisfied, under a current condition, a danger may happen to the carrying apparatus executing the carrying task, and the carrying apparatus is not controlled to execute the carrying task, so that the danger is avoided.

According to the embodiment of the present disclosure, before the carrying task is executed, the image data of the target storage location corresponding to the carrying task is acquired through the image acquisition apparatus, whether the execution condition of the carrying task is satisfied currently is determined according to the image data of the target storage location, and in a case that the execution condition of the carrying task is not satisfied, a danger may happen during execution of the carrying task by the carrying apparatus, and the carrying apparatus does not execute the carrying task temporarily, so that the occurrence of danger is avoided and the safety of warehouse robots is improved.

### Embodiment II

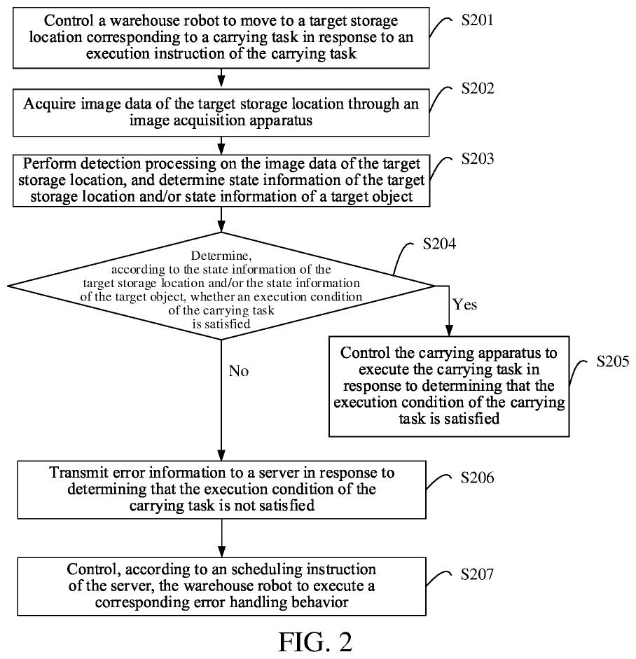

FIG. 2 is a flowchart of a warehouse robot control method provided in embodiment II of the present disclosure. On the basis of embodiment I, in this embodiment, the controlling, according to the image data of the target storage location, the carrying apparatus to execute the carrying task in response to determining that an execution condition of the carrying task is satisfied includes: performing detection processing on the image data of the target storage location, and determining state information of the target storage location and/or state information of a target object; and controlling, according to the state information of the target storage location and/or the state information of the target object, the carrying apparatus to execute the carrying task in response to determining that the execution condition of the carrying task is satisfied. Furthermore, error information is sent to a server according to the image data of the target storage location in response to determining that the execution condition of the carrying task is not satisfied. As shown in FIG. 2, the method includes the following specific steps:

Step S201. Control the warehouse robot to move to the target storage location corresponding to the carrying task in response to an execution instruction of the carrying task.

The execution instruction of the carrying task may be indication information sent by the scheduling system to the warehouse robot for triggering the warehouse robot to execute the carrying task.

The carrying task includes information of the target storage location, a task type, and other information required for executing a current task. Types of the carrying task includes a pickup task and a storage task.

In a case that the execution instruction of the carrying task is received, the processor controls, according to the information of the target storage location corresponding to the carrying task, the warehouse robot to move to the target storage location corresponding to the carrying task.

In this embodiment, the target storage location refers to a storage location corresponding to the carrying task, and the target object refers to an object to be carried in the present carrying task. For example, in a case that the carrying task is picking up goods, the target storage location refers to the storage location from which the goods need to be picked up, and the goods and/or box picked up is the target object. In a case that the carrying task is storing goods, an object to be stored is the target object, and the target storage location refers to the storage location into which the target object is to be stored.

Step S202. Acquire the image data of the target storage location through the image acquisition apparatus.

The warehouse robot is provided with the carrying apparatus for pickup. The carrying apparatus refers to an apparatus for picking up goods from a storage location or storing goods into a storage location, for example, a fork.

The image acquisition apparatus is an apparatus disposed on the warehouse robot and configured to acquire the image data of the storage location. The image acquisition apparatus may be an image sensor such as a black and white camera, a color camera, and a depth camera. For example, the image acquisition apparatus may be a 2D camera, a 3D camera, and a laser radar.

Optionally, the image acquisition apparatus is disposed on the carrying apparatus of the warehouse robot. In a process that the warehouse robot moves to the target storage location, or in a case that the warehouse robot moves to the vicinity of the target storage location, the image acquisition apparatus mounted on the carrying apparatus acquires the image data of the target storage location.

Optionally, the image acquisition apparatus is disposed on the carrying apparatus of the warehouse robot and oriented to the front of the carrying apparatus, such that in a case that the carrying apparatus is aligned with the target storage location, the image acquisition apparatus is aligned with the target storage location and accurately captures the image data of the target storage location.

Furthermore, the processor further controls the carrying apparatus to be aligned with the target storage location by analyzing a current location of the carrying apparatus and a relative location of the target storage location.

Exemplarily, in a case that the warehouse robot moves to a target location corresponding to the target storage location, the processor controls the image acquisition apparatus to start and acquire the image data of the target storage location.

Furthermore, in a case that the warehouse robot moves to the target location corresponding to the target storage location, the processor controls the carrying apparatus to move to the target storage location, such that the image acquisition apparatus mounted on the carrying apparatus is aligned with the target storage location.

Exemplarily, during movement of the warehouse robot to the target location corresponding to the target storage location, in a case that the warehouse robot moves within a preset range around the target storage location, the processor controls the image acquisition apparatus to start in advance and acquire the image data of the target storage location, so as to obtain the image data of the target storage location in advance and perform detection processing, such that whether the execution condition of the carrying task is satisfied is determined as soon as possible, the carrying task is completed in advance, and efficiency is improved. The preset range is set according to actual application scenes, and this is not limited in this embodiment.

In this embodiment, according to the image data of the target storage location, in a case that the execution condition of the carrying task is satisfied, the carrying apparatus is controlled to execute the carrying task, which is specifically implemented by adopting the following steps S203 to S204.

Step S203. Perform detection processing on the image data of the target storage location, and determine state information of the target storage location and/or state information of a target object.

The state information of the target storage location includes at least one of the following:

obstacle information on a carrying path of the target storage location; size information of the target storage location; and whether the target storage location is idle. The carrying path includes a pickup path and/or a storage path.

The state information of the target object includes at least one of the following:

identity information of the target object; pose information of the target object; size information of the target object; damage degree information of the target object; and deformation degree information of the target object.

In this embodiment, according to different carrying tasks, information detected in this step is different. The information detected in this step is merely used for determining whether an execution condition of a current carrying task is executed in a subsequent step, and on the premise that whether the execution condition of the current carrying task is satisfied can be determined, the less information is detected, the higher the efficiency is.

Exemplarily, the detection processing on the image data includes: processing of algorithms such as image filtering, feature extraction, target segmentation, deep learning, point cloud filtering, point cloud extraction, point cloud clustering, point cloud segmentation and point cloud deep learning, and further includes other image processing algorithms in the field of image processing, which are specifically described in detail in subsequent step S204 and will not be repeated here.

Step S204. Determine, according to the state information of the target storage location and/or the state information of the target object, whether an execution condition of the carrying task is satisfied.

Specifically, in a case that the carrying task is picking up goods, the execution condition of the carrying task includes at least one of the following:

no obstacle is present on a pickup path of the target storage location; the identity information, the pose information and the size information of the target object satisfy pickup conditions; a damage degree of the target object falls within a first preset safety threshold range; and a deformation degree of the target object falls within a second preset safety threshold range.

The pickup path refers to a path in a process that the warehouse robot moves to the front of a rack, the carrying apparatus picks up a box (or the target object in the box) from a target storage location, moves the box (or the target object) to a designated location on the warehouse robot (e.g., a cache location on the warehouse robot).

For example, taking the target object being a material box as an example, the carrying task is picking up goods, and in a case that the pose and size of the material box satisfy pickup conditions, and no obstacle is present on the pickup path, a fork is extended out to perform a pickup behavior.

In a case that the carrying task is storing goods, the execution condition of the carrying task includes at least one of the following:

the target storage location is idle; the size of the target storage location satisfies a storage condition; and no obstacle is present on a storage path of the target storage location.

For example, taking the target object as a material box as an example, the carrying task is storing goods, and in a case that a target storage location is empty, the size of the target storage location satisfies a size requirement of the material box, and no obstacle is present on the storage path, a fork is extended out to perform a storage behavior.

The storage path refers to a path in a process that the warehouse robot moves to the front of a rack, the carrying apparatus picks up a box (or the target object in the box) from a designated location on the warehouse robot (e.g., a cache location on the warehouse robot), and moves the box (or the target object) to a target storage location (or a box at the target storage location).

In a possible implementation, two-dimensional image data of the target storage location is acquired by a first camera apparatus.

The first camera apparatus is a camera apparatus capable of acquiring two-dimensional image data, for example, a 2D camera.

Specifically, by adjusting the location of the warehouse robot and/or the carrying apparatus on which the first camera apparatus is located, and adjusting the mounting location of the first camera apparatus on the warehouse robot, the target storage location is located within the field of view of the first camera apparatus.

The processor enables the first camera apparatus to capture an image within the field of view of the first camera apparatus by controlling the first camera apparatus to start. Because the target storage location is located within the field of view of the first camera apparatus, the image data captured by the first camera apparatus includes the target storage location. That is, the first camera apparatus captures the image data of the target storage location and sends to the processor.

For the present implementation, the step includes: the processor performing filtering and denoising processing on the received image data, extracts an area satisfying a specific condition in the image, performing extraction and separation on a target in the image by using a deep learning algorithm to identify targets such as the target storage location in the image, the object in the target storage location and other obstacles, and determining, according to the image processing and identification results, whether the execution condition of the carrying task is satisfied currently, that is, performing image registration by using a deep learning method and determining whether the execution condition of the carrying task is satisfied. This is not limited herein.

The filtering and denoising processing may be applying filtering algorithms such as Gaussian filtering, mean filtering and median filtering.

Exemplarily, the specific condition includes at least one of the following: a specific color, a location in the image, and a pixel value size, etc. The specific condition is set and adjusted according to a specific characteristic of a target to be identified in actual application scenes, and this is not limited in this embodiment.

Exemplarily, feature extraction is performed on the image, and the extracted feature includes at least one of the following: straight lines at edges of the material box, feature points at surfaces of the material box, a specific pattern at a surface of the material box, and a color at a surface of the material box. The feature extraction result includes at least one of the following: an area enclosed by straight lines of the material box, intersection coordinates of the straight lines of the material box, the quantity of feature points, and the area of a specific pattern, etc. According to the feature extraction result, whether the size of the material box satisfies a condition may be determined by determining whether the size of the area enclosed by straight lines of the material box complies with a preset threshold; or, whether the size of the material box satisfies a condition may also be directly identified and determined by using the deep learning method; whether the specific pattern is preset pattern may be determined to determine whether the target is the designated target storage location or target object to be picked up, etc. in the carrying task.

In the present implementation, what features are included in the extracted features, what information is included in the feature extraction result, and a rule for determining whether an execution condition of a carrying task is satisfied currently according to a specific feature extraction result are adjusted according to actual application scenes, and this is not limited in this embodiment.

In the present implementation, any step may be increased or decreased or a sequence thereof may be changed on the basis of specific situations of actual application scenes. Or, other algorithms may be inserted on the basis of real situations to improve a detection effect. This is not limited in this embodiment.

In another possible implementation, three-dimensional point cloud data of the target storage location is acquired by a second camera apparatus.

The second camera apparatus is a camera apparatus capable of acquiring three-dimensional point cloud data, for example, a 3D camera, a 3D laser radar, or a 2D laser radar. The 2D laser radar is capable of acquiring 3D point cloud data by movement.

Specifically, by adjusting the location of the warehouse robot and/or the carrying apparatus on which the second camera apparatus is located, and adjusting the mounting location of the second camera apparatus on the warehouse robot, the target storage location is located within the field of view of the second camera apparatus.

The processor enables the second camera apparatus to capture an image within the field of view of the second camera apparatus by controlling the second camera apparatus to start. Because the target storage location is located within the field of view of the second camera apparatus, the image data captured by the second camera apparatus includes the target storage location. That is, the second camera apparatus captures the image data of the target storage location and sends to the processor.

For the present implementation, in this step, the processor performs sampling processing on the received three-dimensional point cloud data, performs denoising processing on a sampled point cloud, extracts a target area in the point cloud, performs clustering on the point cloud, and determines, according to the clustering result, whether an obstacle is present in a current pickup/storage path and whether the size of the storage location satisfies the execution condition of the carrying task; and extracts state information of an object (material box) in the target area, and determines, according to the state information of the object (material box), whether the object and the storage location satisfy the execution condition of the carrying task.

Exemplarily, extracting the target area in the point cloud is extracting a part the 3D coordinates of which fall within a preset spatial area by determining whether 3D coordinates of the point cloud fall within the preset spatial area. The preset spatial area is set and adjusted according to actual application scenes, and this is not limited in this embodiment.

Exemplarily, in a case that a point cloud object category is present in the target area after clustering, it is determined that an obstacle is present in the pickup/storage path, or the size of the storage location does not satisfy a storage requirement. Otherwise, in a case that no point cloud object category is present in the target area after clustering, it is determined that no obstacle is present in the pickup/storage path, or the size of the storage location satisfies a storage requirement.

Exemplarily, taking the object being a material box as an example, the state information of the object includes at least one of the following: pose, size, flatness and texture.

Exemplarily, taking the object being a material box as an example, determining, according to the state information of the object (material box), whether the object and the storage location satisfy the execution condition of the carrying task includes at least one of the following:

a material box within the field of view of the second camera apparatus can be identified according to state information of the material box, and in a case that state information of a material box within the field of view is captured, it is considered that a material box is located ahead; in a case that a material box state within the field of view is idle, it is considered that no material box is located ahead, and a storage condition is satisfied; in a case that the size of the material box is less than a size threshold, it is considered that a pickup condition is satisfied; in a case that a current placement angle of the material box is within a safe rage of placement angle of the material box, it is considered that the pickup condition is satisfied.

The size threshold and the safe rage of placement angle of a material box are set and adjusted according to actual application scenes, and this is not limited in this embodiment.

In the present implementation, any step may be increased or decreased or a sequence thereof may be changed on the basis of specific situations of actual application scenes. Or, other algorithms may be inserted on the basis of real situations to improve a detection effect. This is not limited in this embodiment.

In a third possible implementation, two-dimensional point cloud data of the target storage location is acquired by a laser radar apparatus, or the two-dimensional point cloud data is acquired by a single point laser rangefinder through movement.

Specifically, by adjusting the location of the warehouse robot and/or the carrying apparatus on which the laser radar apparatus is located, and adjusting the mounting location of the laser radar apparatus on the warehouse robot, the target storage location is located within the field of view of the laser radar apparatus.

The processor enables the laser radar apparatus to scan an image within the field of view of the laser radar apparatus by controlling the laser radar apparatus to start. Because the target storage location is located within the field of view of the laser radar apparatus, the image data captured by the laser radar apparatus includes the target storage location. That is, the laser radar apparatus captures the image data of the target storage location and sends to the processor.

For the present implementation, in this step, the processor performs sampling processing on the received two-dimensional point cloud data, performs denoising processing on a sampled point cloud, extracts a target area in the point cloud, performs clustering on the point cloud, and determines, according to the clustering result, whether an obstacle is present in a current pickup/storage path and whether the size of the storage location satisfies the execution condition of the carrying task; and extracts state information of an object (material box) in the target area, and determines, according to the state information of the object (material box), whether the object and the storage location satisfy the execution condition of the carrying task.

Exemplarily, in a case that a point cloud object category is present in the target area after clustering, it is determined that an obstacle is present in the pickup/storage path, or the size of the storage location does not satisfy a storage requirement. Otherwise, in a case that no point cloud object category is present in the target area after clustering, it is determined that no obstacle is present in the pickup/storage path. In addition, whether the size of the storage location satisfies requirements of storage is determined by calculating the lengths of edges of the storage location and angles formed between the edges of the storage location and determining whether the lengths of the edges and the angles formed by the edges comply with a preset length threshold and an angle threshold. The size threshold and the angle threshold are determined according to sizes of material boxes, and this is not limited in this embodiment.

Exemplarily, taking the object being a material box as an example, the state information of the object includes at least one of the following: angle, size and flatness.

Exemplarily, taking the object being a material box as an example, determining, according to the state information of the object (material box), whether the object and the storage location satisfy the execution condition of the carrying task includes at least one of the following:

a material box within the field of view of the laser radar apparatus can be identified according to state information of the material box, and in a case that state information of a material box within the field of view is captured, it is considered that a material box is located ahead; in a case that a material box state within the field of view is idle, it is considered that no material box is located ahead, and a storage condition is satisfied; in a case that the size of the material box is less than a size threshold, it is considered that a pickup condition is satisfied; in a case that a current placement angle of the material box is within a safe rage of placement angle of the material box, it is considered that the pickup condition is satisfied. The size threshold and the safe rage of placement angle of a material box are set and adjusted according to actual application scenes, and this is not limited in this embodiment.

In the present implementation, any step may be increased or decreased or a sequence thereof may be changed on the basis of specific situations of actual application scenes. Or, other algorithms may be inserted on the basis of real situations to improve a detection effect. This is not limited in this embodiment.

Step S205. Control the carrying apparatus to execute the carrying task in response to determining that the execution condition of the carrying task is satisfied.

In step S204 above, in a case that it is determined that the execution condition of the carrying task is satisfied, under a current condition, no danger may happen to the carrying apparatus executing the carrying task, and the carrying apparatus is controlled to execute the carrying task. For example, a fork is controlled to be extended out to perform a pickup behavior and picks up a box from the target storage location. Or, the fork is controlled to be extended out to perform a storage behavior, and stores a box into the target storage location.

Step S206. send error information to a server in response to determining that the execution condition of the carrying task is not satisfied.

The error information includes at least one of the following: the state information of target storage location, the state information of the target object, and an execution condition item which is not satisfied.

For example, an obstacle is present in the pickup/storage path of the storage location, the pose of the material box exceeds a safe range, the size of the material box exceeds a set range, and a damage degree of the material box exceeds a safe pickup threshold.

In step S204 above, in a case that it is determined that the execution condition of the carrying task is not satisfied, under a current condition, a danger may happen to the carrying apparatus executing the carrying task, and the carrying apparatus is not controlled to execute the carrying task, so that the danger is avoided.

Furthermore, the processor sends error information to the server of the scheduling system, such that the scheduling system guides manual recovery of a working condition of the warehouse robot. For example, the scheduling system sends information to a terminal device of corresponding technical staff and informs the worker how to implement recovery of the working condition.

For example, in a case that the current carrying task is a pickup task, the worker is informed to remove an obstacle in a storage location, adjust the pose of a material box, and remove a heavily damaged material box, etc. For example, in a case that the current carrying task is a storage task, the worker is informed to modify the size of a current storage location, remove an obstacle in a storage location, and remove a material box in the storage location, etc.

Step S207. Control, according to a scheduling instruction of the server, the warehouse robot to execute a corresponding error handling behavior.

In this embodiment, in a case that the execution condition of the carrying task is not satisfied, the processor controls, according to a scheduling instruction of the server, the warehouse robot to execute a corresponding error handling behavior.

The error handling behavior is any one of the following:

stopping at a current location and waiting for an instruction; moving to a target point; and skipping the current carrying task and executing a next carrying task.

Stopping at the current location and waiting for an instruction is the warehouse robot keeping the pose before executing the carrying task (pickup or storage), and not executing any action and standing by in place before the working condition is recovered.

The target point is any point which does not interrupt walking of other robots in a map. Optionally, the processor controls the warehouse robot to move to the target point closest to a current location of the warehouse robot, so as to improve efficiency.

Skipping the current carrying task and executing a next carrying task is giving up acquiring the current material box or giving up storing the current material box, and entering a next material box pickup/storage process.

In another implementation of this embodiment, in a case that the execution condition of the carrying task is not satisfied, after the processor sends the error information to the server, the processor further controls, according to a preset error handling policy, the device to execute a corresponding error handling behavior. That is to say, configurations of an error handling policy are set in advance for the warehouse robot. After an error occurs during an execution process of a carrying task, a corresponding error handling behavior is directly executed according to the preset error handling policy.

According to the embodiment of the present disclosure, an image acquisition apparatus on a warehouse robot acquires image data of a target storage location, which is taken as basic data for determining whether an execution condition of a carrying task is satisfied. No sensor is required to be disposed on each storage location, and the present invention can be flexibly applied to warehousing systems of various types. The universality and flexibility of warehouse robots are improved, and the construction cost and deployment cost are greatly reduced. Furthermore, the warehouse robots are directly applied to a plurality of warehousing systems. Compared with existing sensors, such as an acoustic radar and a gravimeter, which are disposed in storage locations, in this embodiment, an image acquisition apparatus (which may be a 2D camera, a 3D camera, a 3D laser radar, a 2D laser radar and a single point laser rangefinder, etc.) is used to acquire 2D or 3D image data of a target storage location, and on the basis of the image data, detection is performed on the target storage location and a target material box. The detection precision is improved, such that a situation that an execution condition of a carrying task is not satisfied is more accurately determined, the occurrence of dangerous situations is better avoided, and the safety of warehouse robots is improved.

### Embodiment III

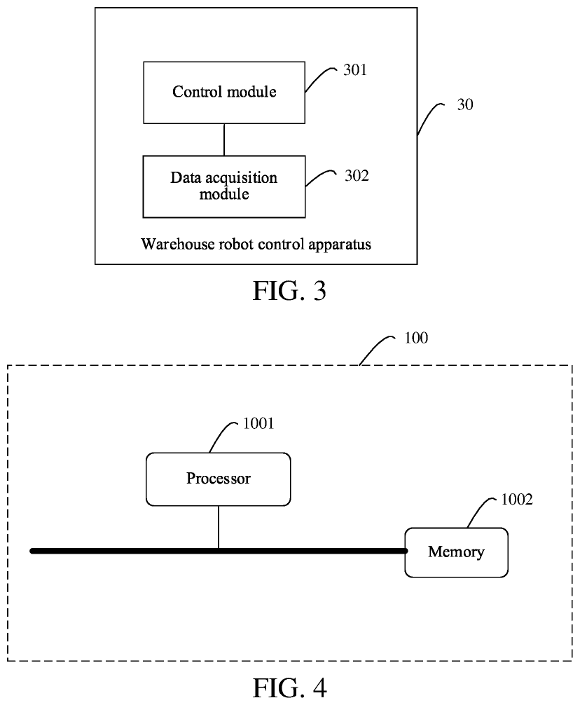

FIG. 3 is a schematic structural diagram of a warehouse robot control apparatus provided in embodiment III of the present disclosure. The warehouse robot control apparatus provided by the embodiment of the present disclosure executes the process flow provided by the warehouse robot control method embodiments. As shown in FIG. 3, the warehouse robot control apparatus 30 includes a control module 301 and a data acquisition module 302.

Specifically, the control module 301 is configured to control a warehouse robot to move to a target storage location corresponding to a carrying task in response to an execution instruction of the carrying task.

The data acquisition module 302 is configured to acquire image data of the target storage location corresponding to the carrying task through the image acquisition apparatus.

The control module 301 is further configured to control, according to the image data of the target storage location, the carrying apparatus to execute the carrying task in response to determining that an execution condition of the carrying task is satisfied.

The apparatus provided by the embodiment of the present disclosure is specifically used for executing the method embodiment provided by embodiment I. The specific functions will not be repeated here.

According to the embodiment of the present disclosure, before the carrying task is executed, the image data of the target storage location is acquired through the image acquisition apparatus, whether the execution condition of the carrying task is satisfied currently is determined according to the image data of the target storage location, and in a case that it is determined that the execution condition of the carrying task is not satisfied, a danger may happen during execution of the carrying task by the carrying apparatus, and the carrying apparatus does not execute the carrying task temporarily, so that the occurrence of danger is avoided and the safety of warehouse robots is improved.

### Embodiment IV

On the basis of embodiment III, in this embodiment, the control module is further configured to:

perform detection processing on the image data of the target storage location, and determine state information of the target storage location and/or a target object; and control, according to the state information of the target storage location and/or the target object, the carrying apparatus to execute the carrying task in response to determining that the execution condition of the carrying task is satisfied.

In a possible implementation, the data acquisition module is further configured to:

control, in a case that the warehouse robot moves to a target location corresponding to the target storage location, the image acquisition apparatus to start and acquire the image data of the target storage location; or control, during movement of the warehouse robot to a target location corresponding to the target storage location, the image acquisition apparatus to start and acquire the image data of the target storage location.

In a possible implementation, the image acquisition apparatus is disposed on the carrying apparatus, and the control modules is further configured to:

control the carrying apparatus to be aligned with the target storage location.

In a possible implementation, the state information of the target storage location includes at least one of the following:

obstacle information on a pickup/storage path of the target storage location; size information of the target storage location; and whether an object is stored at the target storage location.

In a possible implementation, the state information of the target object includes at least one of the following:

identity information of the target object; pose information of the target object; size information of the target object; damage degree information of the target object; and deformation degree information of the target object.

In a possible implementation, in a case that the carrying task is picking up goods, the execution condition of the carrying task includes at least one of the following:

no obstacle is present on a pickup path of the target storage location; the identity, the pose and the size of the target object satisfy pickup conditions; a damage degree of the target object falls within a first preset safety threshold range; and a deformation degree of the target object falls within a second preset safety threshold range.

In a possible implementation, in a case that the carrying task is storing goods, the execution condition of the carrying task includes at least one of the following:

the target storage location is idle; the size of the target storage location satisfies a storage condition; and no obstacle is present on a storage path of the target storage location.

In a possible implementation, the control module is further configured to:

send error information to a server according to the image data of the target storage location in response to determining that the execution condition of the carrying task is not satisfied, where the error information includes at least one of the following: the state information of target storage location, the state information of the target object, and an execution condition item which is not satisfied.

In a possible implementation, the control module is further configured to:

control, according to a scheduling instruction of the server, the warehouse robot to execute a corresponding error handling behavior.

In a possible implementation, the error handling behavior is any one of the following:

stopping at a current location and waiting for an instruction; moving to a target point; and skipping the current carrying task and executing a next carrying task.

In a possible implementation, the data acquisition module is further configured to execute one of the following:

acquiring, by a first camera apparatus, two-dimensional image data of the target storage location; acquiring, by a second camera apparatus, three-dimensional point cloud data of the target storage location; and acquiring, by a laser radar apparatus, two-dimensional point cloud data of the target storage location.

The apparatus provided by the embodiment of the present disclosure is specifically used for executing the method embodiment provided by embodiment II. The specific functions will not be repeated here.

According to the embodiment of the present disclosure, an image acquisition apparatus on a warehouse robot acquires image data of a target storage location, which is taken as basic data for determining whether an execution condition of a carrying task is satisfied. No sensor is required to be disposed on each storage location, and the present invention can be flexibly applied to warehousing systems of various types. The universality and flexibility of warehouse robots are improved, and the construction cost and deployment cost are greatly reduced. Furthermore, the warehouse robots are directly applied to a plurality of warehousing systems. Compared with existing sensors, such as an acoustic radar and a gravimeter, which are disposed in storage locations, in this embodiment, an image acquisition apparatus (which may be a 2D camera, a 3D camera, a 3D laser radar, a 2D laser radar and a single point laser rangefinder, etc.) is used to acquire 2D or 3D image data of a target storage location, and on the basis of the image data, detection is performed on the target storage location and a target material box. The detection precision is improved, such that a situation that an execution condition of a carrying task is not satisfied is more accurately determined, the occurrence of dangerous situations is better avoided, and the safety of warehouse robots is improved.

### Embodiment V

FIG. 4 is a schematic structural diagram of a warehouse robot provided in embodiment V of the present disclosure. As shown in FIG. 4, a device 100 includes: a processor 1001, a memory 1002, and a computer program stored on the memory 1002 and capable of running on the processor 1001.

During the execution of the computer program, the processor 1001 implements the warehouse robot control method provided by any one of the foregoing method embodiments.

According to the embodiment of the present disclosure, an image acquisition apparatus on a warehouse robot acquires image data of a target storage location, which is taken as basic data for determining whether an execution condition of a carrying task is satisfied. No sensor is required to be disposed on each storage location, and the present invention can be flexibly applied to warehousing systems of various types. The universality and flexibility of warehouse robots are improved, and the construction cost and deployment cost are greatly reduced. Furthermore, the warehouse robots are directly applied to a plurality of warehousing systems. Compared with existing sensors, such as an acoustic radar and a gravimeter, which are disposed in storage locations, in this embodiment, an image acquisition apparatus (which may be a 2D camera, a 3D camera, a 3D laser radar, a 2D laser radar and a single point laser rangefinder, etc.) is used to acquire 2D or 3D image data of a target storage location, and on the basis of the image data, detection is performed on the target storage location and a target material box. The detection precision is improved, such that a situation that an execution condition of a carrying task is not satisfied is more accurately determined, the occurrence of dangerous situations is better avoided, and the safety of warehouse robots is improved.

In addition, the embodiment of the present disclosure provides a computer readable storage medium, having a computer program stored therein, and the computer program, when executed by a processor, implements the warehouse robot control method according to any one of the foregoing method embodiments.

A person skilled in the art can easily figure out other implementation solutions of the present disclosure after considering the description and practicing the disclosure disclosed here. The present disclosure is intended to cover any variations, functions, or adaptive changes of the present disclosure. These variations, functions, or adaptive changes comply with general principles of the present disclosure, and include common general knowledge or common technical means in the art that are not disclosed in the present disclosure. The description and the embodiments are considered as merely exemplary, and the true scope and spirit of the present disclosure are indicated in the claims below.

The present invention is not limited to a precise structure that is described above and shown in the accompanying drawings, and can be modified and changed in every way without departing from the scope thereof. The scope of the present disclosure is limited only by the attached claims.

What is claimed is:

1. A warehouse robot control method, the warehouse robot having a carrying apparatus and an image acquisition apparatus, the method comprising:
acquiring image data of a target storage location corresponding to a carrying task through the image acquisition apparatus; and
performing detection processing on the image data of the target storage location, and determining at least one of state information of the target storage location and state information of a target object, wherein the state information of the target storage location comprises obstacle information on a carrying path of the target storage location or size information of the target storage location, and the state information of the target object comprises damage degree information of the target object and deformation degree information of the target object;
controlling, according to the determined at least one of state information, the carrying apparatus to execute the carrying task in response to determining that an execution condition of the carrying task is satisfied;
in case that the carrying task is a pickup task, the execution condition of the carrying task comprises at least one of the following:
no obstacle is present on a pickup path of the target storage location;
the identity information, the pose information and the size information of the target object satisfy pickup conditions;
a damage degree of the target object falls within a first preset safety threshold range; and
a deformation degree of the target object falls within a second preset safety threshold range.

2. The method according to claim 1, wherein the acquiring image data of a target storage location corresponding to a carrying task through the image acquisition apparatus comprises:
controlling, in a case that the warehouse robot moves to a target location corresponding to the target storage location, the image acquisition apparatus to start and acquire the image data of the target storage location;
or
controlling, in a case that the warehouse robot moves within a preset range around the target storage location, the image acquisition apparatus to start and acquire the image data of the target storage location.

3. The method according to claim 2, wherein the image acquisition apparatus is disposed on the carrying apparatus, and before the controlling the image acquisition apparatus to start and acquire the image data of the target storage location, the method further comprises:
controlling the carrying apparatus to be aligned with the target storage location.

4. The method according to claim 1, wherein the carrying task is a storage task, and the execution condition of the carrying task comprises at least one of the following:
the target storage location is idle;
the size of the target storage location satisfies a storage condition; and
no obstacle is present on a storage path of the target storage location.

5. The method according to claim 1, further comprising:
sending error information to a server according to the image data of the target storage location in response to determining that the execution condition of the carrying task is not satisfied, wherein the error information comprises at least one of the following: the state information of target storage location, the state information of the target object, and an execution condition item which is not satisfied.

6. The method according to claim 5, after the sending the error information to the server, further comprising:
controlling, according to a scheduling instruction of the server, the warehouse robot to execute a corresponding error handling behavior.

7. The method according to claim 6, wherein the error handling behavior is any one of the following:
stopping at a current location and waiting for an instruction;
moving to a target point; and
skipping the current carrying task and executing a next carrying task.

8. The method according to claim 1, wherein the acquiring image data of a target storage location through the image acquisition apparatus comprises at least one of the following:
acquiring, by a first camera apparatus, two-dimensional image data of the target storage location;
acquiring, by a second camera apparatus, three-dimensional point cloud data of the target storage location; and
acquiring, by a laser radar apparatus, two-dimensional point cloud data of the target storage location.

9. The method according to claim 1, before the acquiring image data of a target storage location corresponding to a carrying task through the image acquisition apparatus, further comprising:
controlling the warehouse robot to move to the target storage location in response to an execution instruction of the carrying task.

10. A warehouse robot control apparatus, applied to a warehouse robot having a carrying apparatus and an image acquisition apparatus, the warehouse robot control apparatus comprising:
a data acquisition module, configured to acquire image data of a target storage location corresponding to a carrying task through the image acquisition apparatus; and
a control module, configured to perform detection processing on the image data of the target storage location, and determining at least one of state information of the target storage location and state information of a target object, wherein the state information of the target storage location comprises obstacle information on a carrying path of the target storage location or size information of the target storage location, and the state information of the target object comprises damage degree information of the target object and deformation degree information of the target object;
wherein, control, according to the determined at least one of state information, the carrying apparatus to execute the carrying task in response to determining that an execution condition of the carrying task is satisfied;
in case that the carrying task is a pickup task, the execution condition of the carrying task comprises at least one of the following:
no obstacle is present on a pickup path of the target storage location;
the identity information, the pose information and the size information of the target object satisfy pickup conditions;
a damage degree of the target object falls within a first preset safety threshold range; and
a deformation degree of the target object falls within a second preset safety threshold range.

11. A warehouse robot, comprising:
a processor, a memory, and a computer program stored on the memory and running on the processor;
wherein during execution of the computer program, the processor implements the method according to claim 1.
